(19) United States
(12) Patent Application Publication
(10) Pub. No.: US 2018/0215192 A1
(43) Pub. Date: Aug. 2, 2018

(54) DECORATIVE WRITING INSTRUMENT

(71) Applicant: Kristen A. Griffin, Naples, FL (US)

(72) Inventor: Kristen A. Griffin, Naples, FL (US)

(21) Appl. No.: 15/419,305

(22) Filed: Jan. 30, 2017

(51) Int. Cl. B43K 24/00; B43K 29/00

(52) U.S. Cl. CPC B43K 24/00; B43K 29/00

(57) ABSTRACT

A decorative writing utensil (1) having an elongated cylindrical housing (2) containing an ink cartridge, in the case of a pen, or a retractable pencil lead, in the case of a mechanical pencil. The elongated cylindrical housing wrapped in one or more strips (11) of material extending upward to a top end (3) of the cylindrical housing. A pompom (13) is then created on the top end of the cylindrical housing in a manner that leaves a pushbutton (6) accessible through the pompom and still capable of functioning.

### FIELD OF THE INVENTION

This invention relates to a writing utensil, such as retractable pens and mechanical pencils, and more particularly to decorative writing utensils that provide an enjoyable user experience and wherein the decorative elements do not inhibit any mechanical workings of the writing instrument.

### BACKGROUND OF THE INVENTION

Writing instruments, such as pens and pencils, are used in the ordinary course of school, work, social activities, and other matters by children and adults. Conventional pens normally have a plain cylindrical housing containing an ink cartridge. The majority of pens used are “retractable pens,” which have a spring-loaded ink cartridge which retracts and extends outside a protective housing. By clicking downward on a pushbutton located on a top end of the pen, a tip is extended through a conical-shaped end located on the bottom end of the pen and locked into place. The tip may then be retracted into the housing by clicking the pushbutton.

Similar to the retractable pen, is the “mechanical pencil,” which in contrast has a clutch, ratchet or similar internal assembly which incrementally pushes a lead out of the bottom end of the pencil when the pushbutton located on the top end of the pencil is pushed.

Such plain writing instruments do not contain decorative features attractive to users. Conventional decorations, such as attachable caps and erasers, cover the pushbutton and inhibit the use of the writing instrument.

Therefore, a need exists for a decorative writing utensil that provides an enjoyable user experience and wherein the decorative elements do not inhibit any mechanical workings of the writing instrument.

The relevant prior art includes the following references:

| | | |
|---|---|---|
| Pat. No. | Inventor | Issue/Publication Date |

(U.S. Patent References)

| | | |
|---|---|---|
| 4,276,715 | Rogers | Jul. 7, 1981 |
| 6,056,464 | Cohen | May 2, 2000 |
| 6,135,847 | Coates | Oct. 24, 2000 |
| 6,506,465 | Sloot | Jan. 14, 2003 |
| 2004/0161289 | Silberman | Aug. 19, 2004 |
| 2014/0287650 | Owen | Sep. 25, 2014 |

(Foreign Patent References)

| | | |
|---|---|---|
| GB2219255 | Adler | Dec. 6, 1989 |
| CN203198497 | N/A | Sep. 18, 2013 |

(Non-Patent Literature)
http://www.reuseit.com/blog/DIY-Pom-Pom-Pencil-Topper/
http://www.makeandtakes.com/rainbow-loom-bands-pencil-toppers
https://www.npwgifts.com/pom-pom-pencils.html
http://www.shivacharity.com/penciltop.html
http://www.orientaltrading.com/teaching-supplies-and-stationery/stationery/pencil-toppers-a1-553661.fltr

### SUMMARY OF THE INVENTION

The primary object of the present invention is to provide a decorative writing utensil that provides an enjoyable user experience and wherein the decorative elements do not inhibit any mechanical workings of the writing instrument.

The present invention fulfills the above and other objects by providing a decorative writing utensil having an elongated cylindrical housing containing an ink cartridge, in the case of a pen, or a retractable pencil lead, in the case of a mechanical pencil. The elongated cylindrical housing has a top end with a pushbutton located thereon and a bottom end with a conical-shaped tip having an aperture, through which a pen tip or pencil lead is extended.

The cylindrical housing is wrapped in one or more strips of material that are preferably wrapped at an angle beginning on or adjacent to the conical-shaped tip and extending upward to the top end of the cylindrical housing. A pompom is then created on the top end of the pen using the one or more strips of material or other method in a manner that leaves the pushbutton accessible through the pompom and still capable of functioning.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side partial plan view of a decorative writing utensil of the present invention;

FIG. 2 is an exploded side view of a decorative writing utensil of the present invention having a premade pompom being attached thereto;

FIG. 3 is an exploded side view of a decorative writing utensil of the present invention having a pompom made of looped strips being attached thereto; and

FIG. 4 is an exploded side view of a decorative writing utensil of the present invention having a pompom made of a fringed strip being attached thereto.

### DESCRIPTION OF THE PREFERRED EMBODIMENTS

For purposes of describing the preferred embodiment, the terminology used in reference to the numbered accessories in the drawings is as follows:
1. decorative writing utensil, generally
2. cylindrical housing
3. top end of the cylindrical housing
4. bottom end of the cylindrical housing
5. outer surface of the cylindrical housing
6. pushbutton
7. conical-shaped tip
8. aperture of conical-shaped tip
9. apex of conical-shaped tip
10. writing tip
11. wrapping strip
12. pompom
13. loose strip
14. central point of pompom
15. central aperture of pompom
16. attachment means
17. looped strip
18. fringed strip
19. perpendicular slice
20. fringe

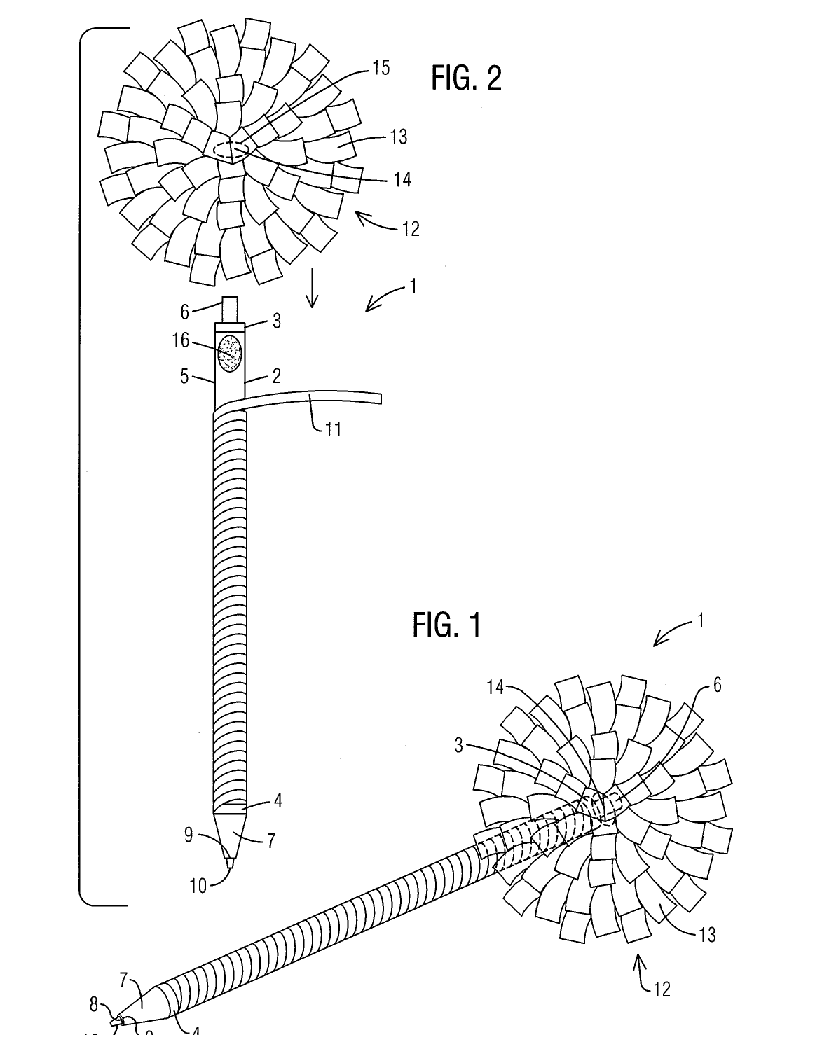

With reference to FIGS. 1-4, the decorative writing utensil 1 of the present invention comprises an elongated cylindrical housing 2 having a top end 3, a bottom end 4 and an outer surface 5. The cylindrical housing 2 may contain an ink cartridge, in the case of a pen, or a retractable pencil lead and associated mechanism, in the case of a mechanical pencil. A pushbutton 6 extending upward from the top end 3 of the cylindrical housing 2. A conical-shaped tip 7 having an aperture 8 located on an apex 9 thereof is located on the bottom end 4 of the cylindrical housing 2. A retractable writing tip 10, such as a pen tip or pencil lead, is extendable and retractable through the aperture 8 of the conical-shaped tip 7 via actuation of the pushbutton 6.

The cylindrical housing 2 is wrapped in at least one wrapping strip 11 of flexible material, such as cloth, leather, ribbon, string, cord, fur and so forth. The at least one strip 11 of material is preferably wrapped around the cylindrical housing 2 at an angle beginning preferably adjacent to the conical-shaped tip 7 and extending upward to the top end 3 of the cylindrical housing 2 terminating below the pushbutton 6. The conical-shaped tip 7 may be removable via threads to allow a user to replace an empty ink cartridge in the case of a pen. Alternatively, the conical-shaped tip 7 may be rotatable to allow a pencil lead to be extended or retracted out of the aperture located thereon. In both of these cases, it is preferable to have the at least one strip 11 of material wrapped around the cylindrical housing 2 at an angle beginning adjacent to the conical-shaped tip 7, thereby not causing any interference with the possible rotation of the conical-shaped tip 7.

A pompom 12 is attached to the top end 3 of the cylindrical housing 2 below the pushbutton 6. The pompom 12 comprises a plurality of loose strips 13 of material extending outward from a central point 14 in a plurality of directions to create a substantially spherical-shaped object.

With reference to FIG. 2, the pompom 12 may be premade and have a central aperture 15 located at the central point 14 which is placed over the bush button 6 and secured to the top end 3 cylindrical housing 2 via an attachment means 16, such as an adhesive, mechanical fastener and so forth and/or being wrapped to the cylindrical housing 2 using the at least one strip 11 of flexible material wrapped around cylindrical housing 2.

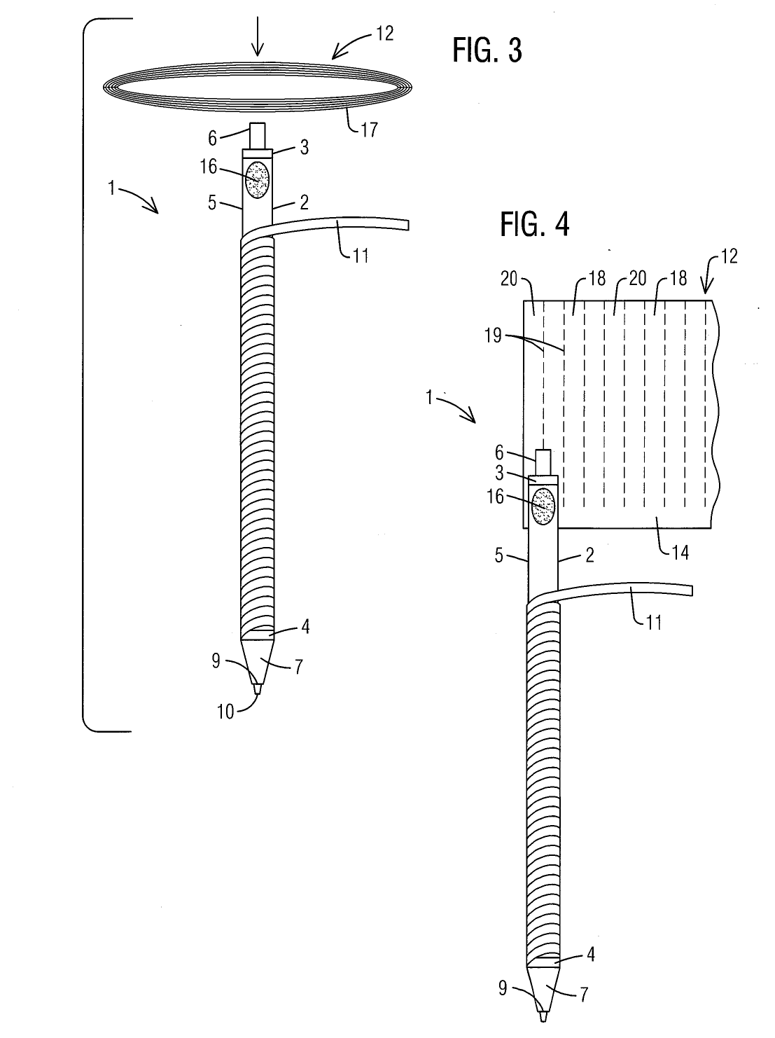

With reference to FIG. 3, the pompom 12 may also be constructed on the top end 3 cylindrical housing 2 by attaching a plurality of looped strips 17 to the top end 3 of the cylindrical housing 2 below the pushbutton 6 via an attachment means, such as an adhesive, mechanical fastener and so forth and/or being wrapped to the cylindrical housing 2 using the at least one strip 11 of flexible material wrapped around cylindrical housing 2, and then cutting the looped strips 17 to create a plurality of loose strips 13 (as illustrated in FIG. 1) extending outward from a central point 14 in a plurality of directions.

With reference to FIG. 4, the pompom 12 may also be created using one or more fringed strips 18 of material having a plurality of perpendicular slices 19 extending partially therethrough to create fringe 20. The one or more fringed strips 18 may be wrapped around the top end 3 of the cylindrical housing 2 below the pushbutton 6 and attached thereto via an attachment means, such as an adhesive, mechanical fastener and so forth and/or being wrapped to the cylindrical housing 2 using the at least one strip 11 of flexible material wrapped around cylindrical housing 2.

In each case, the pompom 12 is attached at the top end 3 cylindrical housing 2 below the pushbutton 6, thereby leaving the pushbutton accessible and functional.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A decorative writing utensil comprising:
an elongated cylindrical housing having a top end, a bottom end and an outer surface;
a pushbutton extending upward from the top end of the cylindrical housing;
a conical-shaped tip located on the bottom end of the cylindrical housing;
said conical-shaped tip having an aperture located on an apex thereof;
a retractable writing tip located within the cylindrical housing and being extendable through aperture of the conical-shaped tip.
said cylindrical-shaped housing being wrapped in at least one wrapping strip; and
a pompom attached to the top end of the cylindrical housing below the pushbutton.

2. The decorative writing utensil of claim 1 wherein:
said at least one wrapping strip is wrapped at an angle extending upward to the top end of the cylindrical housing from the bottom end of the cylindrical housing and terminating below the pushbutton at the top end of the cylindrical housing.

3. The decorative writing utensil of claim 1 wherein:
said pompom comprises plurality of loose strips of material extending outward from a central point in a plurality of directions to create a substantially spherical-shaped object; and
said pompom having a central aperture located at the central point which is placed over the top end cylindrical housing and attached via an at least one attachment means.

4. The decorative writing utensil of claim 1 wherein:
said pompom is constructed on the top end of the cylindrical housing by attaching a plurality of looped strips to the top end of the cylindrical housing below the pushbutton via at least one attachment means.

5. The decorative writing utensil of claim 1 wherein:
said pompom is constructed on the top end cylindrical housing out of at least one fringed strip wrapped around the top end of the cylindrical housing below the pushbutton and attached thereto via at least one attachment means.

6. A decorative writing utensil comprising:
an elongated cylindrical housing having a top end, a bottom end and an outer surface;
a pushbutton extending upward from the top end of the cylindrical housing;
a conical-shaped tip located on the bottom end of the cylindrical housing;
said conical-shaped tip having an aperture located on an apex thereof;
a retractable writing tip located within the cylindrical housing and being extendable through aperture of the conical-shaped tip.
said cylindrical-shaped housing being wrapped in at least one wrapping strip;
a pompom attached to the top end of the cylindrical housing below the pushbutton; and
said at least one wrapping strip is wrapped at an angle extending upward to the top end of the cylindrical housing from the bottom end of the cylindrical housing and terminating below the pushbutton at the top end of the cylindrical housing.

7. The decorative writing utensil of claim 6 wherein:
said pompom comprises plurality of loose strips of material extending outward from a central point in a plurality of directions to create a substantially spherical-shaped object; and
said pompom having a central aperture located at the central point which is placed over the top end cylindrical housing and attached via an at least one attachment means.

8. The decorative writing utensil of claim 6 wherein:
said pompom is constructed on the top end of the cylindrical housing by attaching a plurality of looped strips to the top end of the cylindrical housing below the pushbutton via at least one attachment means.

9. The decorative writing utensil of claim 6 wherein:
said pompom is constructed on the top end cylindrical housing out of at least one fringed strip wrapped around the top end of the cylindrical housing below the pushbutton and attached thereto via at least one attachment means.

10. A decorative writing utensil comprising:
an elongated cylindrical housing having a top end, a bottom end and an outer surface;
a pushbutton extending upward from the top end of the cylindrical housing;
a conical-shaped tip located on the bottom end of the cylindrical housing;
said conical-shaped tip having an aperture located on an apex thereof;
a retractable writing tip located within the cylindrical housing and being extendable through aperture of the conical-shaped tip.
said cylindrical-shaped housing being wrapped in at least one wrapping strip;
a pompom attached to the top end of the cylindrical housing below the pushbutton;
said pompom comprises plurality of loose strips of material extending outward from a central point in a plurality of directions to create a substantially spherical-shaped object; and
said pompom having a central aperture located at the central point which is placed over the top end cylindrical housing and attached via an at least one attachment means.

11. The decorative writing utensil of claim 10 wherein:
said at least one wrapping strip is wrapped at an angle extending upward to the top end of the cylindrical housing from the bottom end of the cylindrical housing and terminating below the pushbutton at the top end of the cylindrical housing.

12. The decorative writing utensil of claim 10 wherein:
said pompom is constructed on the top end of the cylindrical housing by attaching a plurality of looped strips to the top end of the cylindrical housing below the pushbutton via at least one attachment means and cutting the looped strips to create the plurality of loose strips.

13. The decorative writing utensil of claim 10 wherein:
said pompom is constructed on the top end cylindrical housing out of at least one fringed strip wrapped around the top end of the cylindrical housing below the pushbutton.
